(19) United States
(12) Patent Application Publication
(10) Pub. No.: US 2025/0024335 A1
(43) Pub. Date: Jan. 16, 2025

(54) COMMUNICATION METHOD, TERMINAL, AND NETWORK DEVICE

(71) Applicant: GUANGDONG OPPO MOBILE TELECOMMUNICATIONS CORP., LTD., Dongguan (CN)

(72) Inventors: Yang LIU, Dongguan (CN); Cong SHI, Dongguan (CN)

(21) Appl. No.: 18/903,735

(22) Filed: Oct. 1, 2024

Related U.S. Application Data
(63) Continuation of application No. PCT/CN2022/098987, filed on Jun. 15, 2022.

(51) Int. Cl. H04W 36/00

(52) U.S. Cl. CPC H04W 36/0079; H04W 36/00222; H04W 36/0058

(57) ABSTRACT

A communication method, a terminal, and a network device are provided. The communication method includes: performing, by a terminal, a first handover from a first cell to a second cell for enabling the terminal to perform a first service, where the first cell does not support the first service, and the second cell supports the first service; and in a case that the first handover fails, or radio link failure occurs after the first handover succeeds, transmitting, by the terminal, first information, where the first information is used for optimizing mobility network parameter setting and/or performing mobility robust optimization.

### CROSS-REFERENCE TO RELATED APPLICATIONS

This application is a continuation of International Application No. PCT/CN2022/098987, filed on Jun. 15, 2022, the disclosure of which is hereby incorporated by reference in its entirety.

### TECHNICAL FIELD

This application relates to the field of communications technologies, and more specifically, to a communication method, a terminal, and a network device.

### BACKGROUND

It is proposed in some communications systems of a mobility robust optimization (MRO) function, to optimize an improper mobility network parameter (for example, a handover parameter). For example, when detecting a phenomenon of a too early handover, a network device may, based on the MRO function, change a threshold for triggering, by a terminal, reporting of a measurement report.

For a case that the terminal is handed over from a first cell that does not support a first service to a second cell that supports the first service, because the handover is not caused for poor signal quality of the first cell, MRO for this handover is different from MRO for the too early handover. The handover in this special scenario cannot be optimized by using an optimization method for the too early handover.

### SUMMARY

This application provides a communication method, a terminal, and a network device. Various aspects as involved in this application are described below.

According to a first aspect, a communication method is provided, including: performing, by a terminal, a first handover from a first cell to a second cell for enabling the terminal to perform a first service, where the first cell does not support the first service, and the second cell supports the first service; and in a case that the first handover fails, or radio link failure occurs after the first handover succeeds, transmitting, by the terminal, first information, where the first information is used for optimizing mobility network parameter setting and/or performing mobility robust optimization.

According to a second aspect, a communication method is provided, including: in a case that a first handover fails, or radio link failure occurs after the first handover succeeds, receiving, by a network device, first information, where the first information is used for optimizing mobility network parameter setting and/or performing mobility robust optimization. The first handover is a handover of a terminal from a first cell to a second cell for enabling the terminal to perform a first service, the first cell does not support the first service, and the second cell supports the first service.

According to a third aspect, a terminal is provided, including: a handover unit, configured to perform a first handover from a first cell to a second cell for enabling the terminal to perform a first service, where the first cell does not support the first service, and the second cell supports the first service; and a first transmitting unit, configured to: in a case that the first handover fails, or radio link failure occurs after the first handover succeeds, transmit first information, where the first information is used for optimizing mobility network parameter setting and/or performing mobility robust optimization.

According to a fourth aspect, a network device is provided, including: a first receiving unit, configured to: in a case that a first handover fails, or radio link failure occurs after the first handover succeeds, receive first information, where the first information is used for optimizing mobility network parameter setting and/or performing mobility robust optimization MRO. The first handover is a handover of a terminal from a first cell to a second cell for enabling the terminal to perform a first service, the first cell does not support the first service, and the second cell supports the first service.

According to a fifth aspect, a terminal is provided, including: a processor, a memory, and a communications interface. The memory is configured to store one or more computer programs, and the processor is configured to invoke the computer program in the memory to cause the terminal device to execute some or all of the steps in the method according to the first aspect.

According to a sixth aspect, a network device is provided, including: a processor, a memory, and a communications interface, where the memory is configured to store one or more computer programs, and the processor is configured to invoke the computer program in the memory to cause the network device to execute some or all of the steps in the method according to the second aspect.

According to a seventh aspect, an embodiment of this application provides a communications system, where the system includes the foregoing terminal and/or network device. In another possible design, the system may further include another device that interacts with the terminal or the network device in the solution provided in embodiments of this application.

According to an eighth aspect, an embodiment of this application provides a computer-readable storage medium. The computer-readable storage medium stores a computer program. The computer program causes a terminal to execute some or all of steps of the methods according to the foregoing aspects.

According to a ninth aspect, an embodiment of this application provides a computer program product. The computer program product includes a non-transitory computer-readable storage medium that stores a computer program. The computer program is operable to cause a terminal to execute some or all of steps of the methods according to the foregoing aspects. In some implementations, the computer program product may be a software installation package.

According to a tenth aspect, an embodiment of this application provides a chip. The chip includes a memory and a processor, and the processor may invoke a computer program from the memory and run the computer program, to implement some or all of the steps of the method according to the foregoing aspects.

### BRIEF DESCRIPTION OF DRAWINGS

FIG. 1 shows a wireless communications system to which an embodiment of this application is applied.

FIG. 2 is an example diagram of a scenario of a too early handover.

FIG. 3 is a schematic flowchart of a communication method according to an embodiment of this application.

FIG. 4 is a schematic flowchart of a communication method according to Embodiment 1 of this application.

FIG. 5 is a schematic flowchart of a communication method according to Embodiment 2 of this application.

FIG. 6 is a schematic flowchart of a communication method according to Embodiment 3 of this application.

FIG. 7 is a schematic structural diagram of a terminal according to an embodiment of this application.

FIG. 8 is a schematic structural diagram of a network device according to an embodiment of this application.

FIG. 9 is a schematic structural diagram of a communications apparatus according to an embodiment of this application.

### DESCRIPTION OF EMBODIMENTS

The technical solutions in this application are described below with reference to the accompanying drawings.

### Communications System

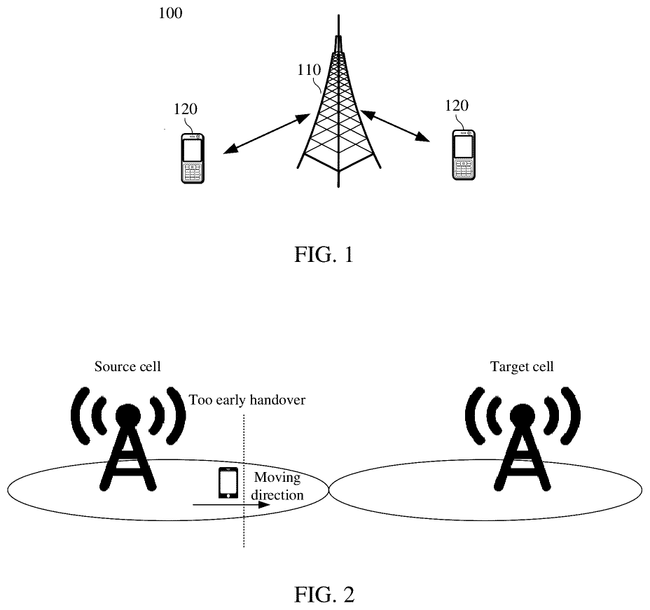

FIG. 1 shows a wireless communications system 100 to which an embodiment of this application is applied. The wireless communications system 100 may include a network device 110 and a terminal device 120. The network device 110 may be a device that communicates with the terminal device 120. The network device 110 may provide communication coverage for a specific geographic area, and may communicate with a terminal device 120 located within the coverage area.

FIG. 1 exemplarily shows one network device and two terminals. Optionally, the wireless communications system 100 may include a plurality of network devices, and another quantity of terminal devices may be included in the coverage of each network device, which is not limited in embodiments of this application.

Optionally, the wireless communications system 100 may further include other network entities such as a network controller and a mobility management entity, which is not limited in embodiments of this application.

It should be understood that technical solutions of embodiments of this application may be applied to various communications systems, such as a 5th generation (5G) system or new radio (NR), a long-term evolution (LTE) system, an LTE frequency division duplex (FDD) system, and LTE time division duplex (TDD) system. The technical solutions provided in this application may further be applied to a future communications system, such as a sixth generation mobile communications system or a satellite communications system.

The terminal device in embodiments of this application may also be referred to as user equipment (UE), an access terminal, a user unit, a user station, a mobile site, a mobile station (MS), a mobile terminal (MT), a remote station, a remote terminal, a mobile device, a user terminal, a terminal, a wireless communications device, a user agent, or a user apparatus. The terminal device in embodiments of this application may refer to a device providing a user with voice and/or data connectivity and capable of connecting people, objects, and machines, such as a handheld device or vehicle-mounted device having a wireless connection function. The terminal device in embodiments of this application may be a mobile phone, a tablet computer (Pad), a notebook computer, a palmtop computer, a mobile internet device (MID), a wearable device, a virtual reality (VR) vehicle, an augmented reality (AR) device, a wireless terminal in industrial control, a wireless terminal in self driving, a wireless terminal in remote medical surgery, a wireless terminal in a smart grid, a wireless terminal in transportation safety, a wireless terminal in smart city, a wireless terminal in smart home, or the like. Optionally, the UE may be used to act as a base station. For example, the UE may act as a scheduling entity, which provides a sidelink signal between UEs in V2X or D2D, or the like. For example, a cellular phone and a vehicle communicate with each other through a sidelink signal. A cellular phone and a smart home device communicate with each other, without the relay of a communication signal through a base station.

The network device in embodiments of this application may be a device for communicating with the terminal device. The network device may also be referred to as an access network device or a wireless access network device. For example, the network device may be a base station. The network device in embodiments of this application may refer to a radio access network (RAN) node (or device) that connects the terminal device to a wireless network. The base station may broadly cover various names below, or may be replaced with the following names, such as a NodeB, an evolved NodeB (eNB), a next generation NodeB (gNB), a relay station, an access point, a transmitting and receiving point (TRP), a transmitting point (TP), a master MeNB, a secondary SeNB, a multi-standard radio (MSR) node, a home base station, a network controller, an access node, a wireless node, an access point (AP), a transmission node, a transceiver node, a base band unit (BBU), a remote radio unit (RRU), an active antenna unit (AAU), a remote radio head (RRH), a central unit (CU), a distributed unit (DU), and a positioning node. The base station may be a macro base station, a micro base station, a relay node, a donor node, or the like, or a combination thereof. Alternatively, the base station may be a communications module, a modem, or a chip disposed in the device or the apparatus described above. Alternatively, the base station may be a mobile switching center, a device that functions as a base station in device-to-device D2D, vehicle-to-everything (V2X), and machine-to-machine (M2M) communication, a network-side device in a 6G network, a device that functions as a base station in a future communications system, or the like. The base station may support networks with a same access technology or different access technologies. A specific technology and specific device form used by the network device are not limited in embodiments of this application.

The base station may be fixed or mobile. For example, a helicopter or an unmanned aerial vehicle may be configured to serve as a mobile base station, and one or more cells may move according to a location of the mobile base station. In other examples, a helicopter or an unmanned aerial vehicle may be configured to serve as a device in communication with another base station.

In some deployments, the network device in embodiments of this application may refer to a CU or a DU, or the network device includes a CU and a DU. The gNB may further include an AAU.

The network device and the terminal device may be deployed on land, including being indoors or outdoors, handheld, or vehicle-mounted, may be deployed on a water surface, or may be deployed on a plane, a balloon, or a satellite in the air. In embodiments of this application, a scenario where the network device and the terminal device are located is not limited.

It should be understood that all or some of functions of the communications device in this application may also be implemented by software functions running on hardware, or by virtualization functions instantiated on a platform (for example, a cloud platform).

### Too Early Handover Optimization

When a terminal is in a service connection state and maintains service, the terminal may move, for example, from one cell to another cell. As the terminal moves, an original serving cell cannot continue to provide a service for the terminal. In this case, cell handover (HO) may be performed, so that the terminal is handed over from a source cell to a target cell, and the target cell may continue to provide the service for the terminal, to ensure that the service is not interrupted.

The terminal may periodically measure signal quality of a cell, and may report a measurement report to a base station when a measurement event (namely, a certain condition) is met. A network device determines, based on the measurement report reported by the terminal, whether to perform cell handover. A condition for reporting a measurement report event may be configured by the network device for the terminal.

A too early handover (too early HO) may occur during cell handover. A process of the too early handover may be as follows: in a case that a handover fails or radio link failure (RLF) occurs on a target cell after completion of a handover during a process in which a terminal accesses the target cell from a source cell, the terminal may perform cell selection, select the source cell again, and initiate reestablishment with the source cell. In other words, after the handover fails or the handover succeeds, the source cell is selected by the terminal again to continue to serve the terminal. As shown in FIG. 2, the terminal may move in a moving direction shown in FIG. 2, and the terminal performs a handover at a location shown in FIG. 2. At the location shown in FIG. 2, signal quality of the source cell is relatively strong, and signal quality of the target cell is relatively weak. Thus, the terminal fails to be handed over to the target cell, and accesses the source cell again. It may be understood that a reason for a handover failure is too early to perform the handover. That is to say, if the handover occurs later, and the terminal continues to move in the moving direction, the terminal may move to a location where signal quality of the target cell is relatively strong and signal quality of the source cell is relatively weak. In this case, a success rate of the cell handover will increase.

The network device may optimize a phenomenon of the too early handover, so as to improve a success rate of a handover. For example, it is proposed in some communications systems of a mobility robust optimization (MRO) function, to optimize mobility network parameter setting, for example, to optimize an improperly set handover parameter. In an implementation, when detecting the too early handover, the network device may, based on the MRO function, change setting of a threshold of a measurement target corresponding to a measurement report event, for example, change a threshold for triggering, by the terminal, reporting of a measurement report.

In a case of a too early handover, the terminal may transmit, to the network device, a radio link failure report (RLF report) related to a cell handover failure (HOF), to enable the network device to perform too early handover optimization. The following describes in detail a process in which the terminal reports a radio link failure report. The process may include steps S110 and S120.

S110. The terminal stores a radio link failure report. In an access process, after a timer T304 expires, the terminal may store the radio link failure report. Alternatively, after the terminal successfully accesses a target cell, RLF occurs in the target cell because a timer T310 expires, or another reason. In this case, the terminal may store the radio link failure report.

S120. The terminal transmits the radio link failure report. The terminal may initiate a reestablishment process with a cell. After reestablishment is completed or a radio resource control (RRC) connection is established, the terminal may transmit, to a reestablished cell, the radio link failure report related to a previous HOF. Step S120 may include steps S121 to S123.

Step S121: The terminal transmits, to the network device, a message that the terminal includes RLF or HOF information. For example, the terminal may notify, through RRC signalling, the network device that related information is stored. The RRC signalling may be, for example, an RRC establishment complete (RRCReestablishmentComplete) message of a message 5 (msg5), and the message may carry an available field of RLF information (rlf-InfoAvailable), to notify the terminal that RLF or HOF information is stored in varRLF-Report.

Step S122: The network device transmits information that requires the terminal to report the RLF or HOF. For example, the network device may transmit RRC signalling to the terminal. The RRC signalling may be, for example, terminal information request (UEInformationRequest) signalling. In the UEInformationRequest signalling, if rlf-ReportReq is a true value, it may indicate that the terminal is required to report the RLF or HOF information.

Step S123: The terminal reports a radio link failure report. The terminal may perform reporting by using RRC signalling. The RRC signalling may be, for example, terminal information response (UEinformationResponse) signalling. In the UEinformationResponse signalling, rlf-Report may be set as a value stored in a variable varRLF-Report of the terminal.

The network device may determine, based on an information block in the radio link failure report, that handover failure or RLF is caused by a too early handover. The information block in the radio link failure report may include one or more of the following information: a measurement result of a last serving cell (measResultLastServCell), a signal measurement result of a neighboring cell (a neighboring cell with a strong signal and a measurement result thereof are placed at the front of a menu list), geographic location information, an identity of a target cell at the time of occurrence of a handover failure, connection failure time (timeConnFailure), an identity of a reconnected cell, an identity of a previous primary cell (previousPCellId), or a connection failure type.

The measurement result of a last serving cell may be obtained through calculation, for example, may be a source cell signal measurement result obtained through calculation based on available measurement on SSB and CSI-RS before the terminal detects the RLF.

The geographic location information may be information about a location where the terminal is located when the RLF occurs.

The connection failure time may be a time frame from the time at which a last handover occurs (reception of the last RRCReconfiguration msg) to the time at which a connection failure occurs (UE reported timer).

In a case of a too early handover, the identity of a reconnected cell may be a source cell identity, and the identity of a previous primary cell may also be the source cell identity.

The connection failure type may include handover failure (HOF) or radio link failure (RLF).

In some embodiments, if a timer (including timeConneFailure) reported by the terminal is less than a threshold (for example, Tstore_UE_cntxt), and a cell that the terminal attempts to reestablish connection with or reconnect with is a source cell previous to the occurrence of a handover, it may be determined that a too early handover problem occurs. In some embodiments, in the radio link failure report, if a failed source cell identity (failledPCellID) is an identity (ID) of a source cell, and the connection failure type (connectionFailureType) is handover failure (‘hof’), or if a failed primary cell identity (failledPCellID) is an identity of a target cell, and the connection failure type is radio link failure (‘rlf’), it may be determined that a too early handover problem occurs.

### Cell Handover in Special Scenarios

A cell handover may also be applied to some special scenarios. For example, in a case that a source cell does not support a certain service, a terminal may be handed over to a target cell that supports the service. A voice service is used as an example. In a scenario in which a cell does not support the voice service, when a terminal initiates establishment of a voice related service, a network device may hand over or redirect the terminal to a suitable cell that supports the voice service. For example, during initial deployment of 5G or in a scenario in which a voice service is not supported by 5G, a 5G network may hand over/redirect a terminal to a suitable network corresponding to a radio technology that supports the voice service, for example, an LTE network. In some embodiments, the foregoing handover performed for supporting a voice service may be referred to as an inter-system handover for voice fallback (HO for voice fallback).

If a measurement result of a target cell is not good enough or there is no enough random access resource, a handover of the terminal may not be completed successfully. In this case, the terminal may perform cell selection or cell reselection to find a suitable cell that supports the first service to camp on. An inter-system handover for voice backoff is used as an example, and the terminal may attempt to find a suitable evolved universal terrestrial radio access network (E-UTRAN) cell. If the terminal finds a suitable cell, the terminal may return to an idle state (RRC_IDLE) and camp on the suitable cell. If the terminal does not find a suitable cell, the terminal may reestablish a connection to a source primary cell (source PCell).

### Cell Selection Criterion

As mentioned above, after a handover fails or RLF occurs after the handover, a terminal may perform cell selection or cell reselection to find a suitable cell. Cell selection may be implemented by using a cell selection criterion (S criterion). The following describes the cell selection criterion.

A cell selection parameter may include, for example, at least one of the following parameters: a minimum required receive level in a cell (minimum required RX level in the cell), a minimum required quality level in a cell (minimum required quality level in the cell), a reference signal received power (RSRP) measured by a terminal device, reference signal received quality (RSRQ) measured by a terminal device, an offset of a minimum required receive level in a cell, an offset applied to a cell temporarily, an offset of a minimum required quality level in a cell, an offset temporarily applied to a cell, power compensation, and a parameter for some special scenarios.

It should be noted that the minimum required receive level in a cell may also be referred to as a minimum RSRP required by a network device. The minimum required quality level in a cell may also be referred to as a minimum RSRQ required by a network device. The offset of a minimum required receive level in a cell and the offset of a minimum required quality level in a cell are offsets for preventing the ping-pong effect generated between two public land mobile networks (PLMN) due to fluctuations in a radio environment. The power compensation is a larger value of 0 and a difference between a maximum transmit power value and a maximum radio frequency output power value of the terminal device. The offset applied to a cell temporarily may be used for a special scenario, for example, may be used in a “thousands of leaves problem” scenario, and may not be applied in a normal case.

Based on the foregoing cell selection criterion parameters, a cell selection criterion may be as follows: when a cell selection receive level value Srxlev and a cell selection quality value Squal of a cell are both greater than 0, the cell is a suitable cell, and a terminal may select the cell. Calculation formulas of Srxlev and Squal are as follows:

$$Srxlev = {Q}_{rxlevmeas} - ( {Q}_{rxlevmin} + {Q}_{rxlevminoffset} ) - {P}_{compensation} \\ Squal = {Q}_{qualmeas} - ( {Q}_{qualmin} + {Q}_{qualminoffset} )$$

Qᵣₓₗₑᵥₘₑₐₛ and Q_{qualmeas} may be respectively RSRP and RSRQ measured by a terminal device.

Qᵣₓₗₑᵥₘᵢₙ and Q_{qualmin} may be respectively a minimum RSRP required by the network device and a minimum RSRQ required by the network device.

Q_{rxlevminoffset} and Q_{qualminoffset} may be respectively an offset of a minimum required receive level in a cell and an offset of a minimum required quality level in a cell. For example, Q_{rxlevminoffset} and Q_{qualminoffset} may be offsets that need to be used when the terminal device camps on a suitable cell of a visited PLMN and periodically searches for a PLMN with a higher priority.

P_{compensation} may be power compensation. For example, when a maximum transmit power allowed by the network device is greater than a maximum uplink transmit power determined by a terminal device's own capability, and P_{compensation} may be power compensation caused due to a low power of the terminal device.

The terminal device may obtain a cell selection criterion parameter from a message transmitted by the network device. The offset of a minimum required receive level in a cell is used as an example. The terminal device may receive a system message transmitted by the network device, and acquire, from a parameter q-RxLevMinCE in the system message, a minimum RSRP required by the network device, namely, Qᵣₓₗₑᵥₘᵢₙ in the foregoing formula.

A definition and a calculation manner of the cell reselection parameter are similar to those of the cell selection parameter, and the details thereof are not described in this application again.

It may be learned from the foregoing that, for a case that a terminal is handed over from a source cell that does not support a first service to a target cell that supports the first service, because the handover is not caused for poor signal quality of the source cell, MRO for this handover is different from MRO for a too early handover. The handover in this special scenario cannot be optimized by using an optimization method for the too early handover.

An inter-system handover for voice backoff is used as an example. Even if signal quality of a 5G source cell is good, a terminal needs to access a target cell that supports a voice service to proceed with a voice service. Therefore, for the inter-system handover for voice backoff, a lower threshold for triggering reporting of a measurement report is generally set, so as to improve a probability that the terminal can be handed over to an LTE cell. Correspondingly, there is also a difference in optimization policies regarding a threshold for triggering reporting of a measurement report. Therefore, with respect to the MRO for the voice backoff, the optimization of a threshold or a handover event for triggering reporting of a measurement report is different from that of the threshold or the handover event for triggering reporting of the measurement report in a case of a too early handover. In other words, a threshold for triggering reporting of the measurement report, which is optimized for the too early handover, cannot be applied to the MRO for voice backoff.

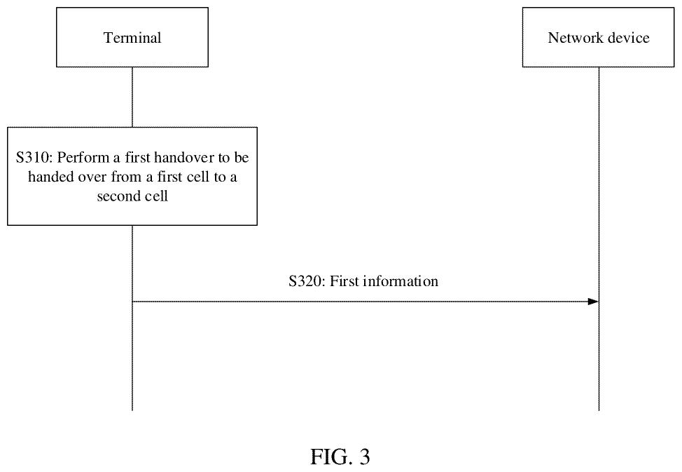

FIG. 3 is a schematic flowchart of a communication method according to an embodiment of this application, in which a handover of a terminal from a source cell that does not support a first service to a target cell that supports the first service is optimized.

The method illustrated in FIG. 3 may be executed by a terminal device and a network device. The network device may be a first network device to which a first cell belongs, a second network device to which a second cell belongs, a third network device that a cell on which the terminal camps after a first handover belongs to, or a fourth network device to which a cell around the terminal belongs. It may be understood that any two or more of the first network device, the second network device, or the third network device may be a same network device.

The method illustrated in FIG. 3 may include steps S310 and S320.

Step S310: A terminal performs a first handover to be handed over from a first cell to a second cell.

The first cell may not support a first service. The second cell may support the first service. In some embodiments, the first service may be a voice service. Correspondingly, the first handover may be an inter-system handover for voice fallback. For example, the first cell may be a 5G cell. The second cell may be an LTE cell. The 5G cell may not support a voice service, and the LTE cell may support the voice service.

A purpose of the first handover may be to enable the terminal to execute the first service. It may be understood that the terminal cannot execute the first service in the first cell. Through the first handover, the terminal may be handed over to the second cell, to enable the terminal to execute the first service. In the first handover, the first cell may be a source cell, and the second cell may be a target cell.

The following uses an example in which the first service is a voice service, and the first handover is an inter-system handover for voice fallback, to describe a process of the first handover. The process of the first handover may include, for example, S311 to S314.

Step S311: The network device updates a measurement configuration for a cell handover. Step S311 may be performed after the network device receives a request for establishing a voice service from the terminal. The terminal may request to establish a QoS flow for a voice flow (5QI=1). That the first cell is a 5G cell and the second cell is an LTE cell is used as an example. In a new measurement configuration, a measurement target may be a corresponding frequency of LTE, and a related parameter for measurement reporting may be set with respect to an event B1. The event B1 may be that quality of a neighboring cell (that is, a heterogeneous neighboring cell) of an inter-radio access technology (RAT) is higher than a specific threshold (inter RAT neighbor becomes better than a certain threshold).

Step S312: The terminal reports a measurement report. After the terminal performs a measurement on a neighboring LTE cell, if a measurement result obtained meets settings from the network device, the terminal may report the measurement report. For example, in a case that the measurement result of the LTE cell is greater than a threshold for triggering reporting of the measurement report, the terminal may report the measurement report.

Step S313: The first handover is performed. The network device may search for a suitable target cell for the terminal, and query whether the target cell accepts the handover. After the target cell responds and accepts the handover, the network device may transmit indication information to the terminal to instruct the terminal to perform the handover. The target cell may be the second cell. For example, the network device may transmit, to the terminal, signalling MobilityFromNRCommand (MobilityFromNRCommand) that carries indication information voiceFallbackIndication (voiceFallbackIndication), so as to instruct the terminal to perform inter-RAT handover.

Step S314: The terminal performs random access to the second cell, so as to be handed over to the second cell.

The first handover may require optimization, such as MRO. In some embodiments, the first handover may fail. Failure of the first handover may be caused by a problem encountered in a process in which the terminal performs random access to the second cell. For example, the terminal fails to receive message 2 (msg2) transmitted by the network device, which may cause a problem in a random access procedure. Alternatively, in contention-based random access, contention failure of the terminal may cause a problem in a random access procedure. Alternatively, that the second cell has not allocated a dedicated random access resource to the terminal may cause a problem in a random access procedure. In some other embodiments, radio link failure may further occur after the first handover succeeds. In foregoing embodiments, it may be determined that the first handover requires optimization.

In some embodiments, the network device may determine, based on information carried in a radio link failure report, whether radio link failure or handover failure occurs. For example, in the radio link failure report, if a connection failure type is RLF and timeConnFailure is less than a threshold, the network device may determine that RLF occurs after the first handover. Alternatively, in the radio link failure report, if the connection failure type is a handover failure, the network device may determine that the first handover fails.

According to this application, step S320 may be performed in a case that the first handover fails or the radio link failure occurs after the first handover succeeds.

Step S320: The terminal may transmit first information. The network device may receive the first information.

The first information may be used for optimizing mobility network parameter setting and/or performing mobility robustness optimization. For example, the first information may be used for indicating optimization of mobility network parameter setting and/or mobility robustness optimization for the first handover. It may be understood that the mobility robustness optimization may optimize setting of a mobility network parameter. In other words, the optimization of the mobility network parameter setting may be implemented by means of mobility robustness optimization.

A type of the mobility robustness optimization may be determined based on the first information. For example, mobility network parameter setting optimization and/or mobility robustness optimization may be performed on the first handover in a targeted manner, so as to provide an optimization policy for the first handover.

In some embodiments, optimization of mobility network parameter setting and/or mobility robustness optimization may include adjusting a threshold for triggering reporting of a measurement report. For example, the network device may adjust a threshold for triggering reporting of the measurement report of event B1. In some implementations, the network device may increase or decrease the threshold for triggering reporting of the measurement report.

In some embodiments, mobility network parameter setting optimization and/or mobility robustness optimization may include adjusting one or more cell selection parameters or cell reselection parameters. The cell selection parameter or cell reselection parameter may be a parameter related to a cell selection criterion or a cell reselection criterion. For example, the cell selection parameter or cell reselection parameter may include the following parameters: a minimum required receive level in a cell, a minimum required quality level in a cell, a reference signal received power measured by a terminal device, reference signal received quality measured by a terminal device, an offset of a minimum required receive level in a cell, an offset applied to a cell temporarily, an offset of a minimum required quality level in a cell, an offset applied to a cell temporarily, power compensation, and the like.

A trigger condition for transmitting the first information is not limited in this application. For example, the terminal may immediately transmit the first information after the first handover fails, or after radio link failure occurs following the success of the first handover. Alternatively, the terminal may store the first information, and transmit, to the network device, first indication information for indicating that the first information is stored in the terminal. The network device may learn, based on the first indication information, that the first information is stored in the terminal. If expecting to acquire the first information, the network device may transmit, to the terminal, second indication information for acquiring the first information. After receiving the second indication information for acquiring the first information, the terminal may transmit the first information to the network device.

The first information may include information related to the first service. That the first service is a voice service is used as an example. The first information may include indication information related to that the first handover is for the purpose of voice backoff.

The first information may be transmitted separately, or may be transmitted together with other information. For example, the first information may be carried in a first report. The first report may be, for example, a radio link failure report. The first report may be generated by the terminal. For example, in a case of failing to performing handover to access the second cell, the terminal may generate the first report.

The first report may include the first information, or may include other information. The other information may include another information block in the radio link failure report. For example, the first report may include one or more of the following information: a connection failure type, an identity of a first cell (or referred to as a source cell identity), an identity of a second cell (or referred to as a target cell identity), a wireless signal measurement result of a neighboring cell of a target RAT previous to failure of a first handover or execution of the first handover, a wireless signal measurement result of a second cell previous to the failure of the first handover or the execution of the first handover, a random access condition in a process of accessing a second cell, a cause value of RLF or HOF, a geographical location of the terminal, or the like.

The connection failure type may include: RLF or HOF. The connection failure type may be indicated with an identity of the RLF or an identity of the HOF.

The cause value of RLF or HOF may include: timer T310 expiry (t310-Expiry), (random access problem) randomAccessProblem, call drop for RLC maximum number of retransmissions (rlc-MaxNumRetx), beam failure recovery failure (beamFailureRecoveryFailure), listen before talk failure (lbtFailure-r16), radio backhaul RLF recovery failure (bh-rlfRecoveryFailure), and the like.

In a case that the first handover fails, or radio link failure occurs after the first handover succeeds, the terminal may perform cell selection or cell reselection to search for a suitable cell.

The wireless signal measurement result of a neighboring cell may include measurement results of a plurality of neighboring cells. The plurality of neighboring cells and corresponding measurement results may be represented through a list. Optionally, a neighboring cell with better signal quality and a measurement result of the neighboring cell may be located at the front of a plurality of measurement results.

The suitable cell may be a cell that meets a cell selection criterion or a cell reselection criterion. The suitable cell may be a cell that supports a first service. That the first service is a voice service is used as an example, and a cell that supports the first service may be an E-UTRAN cell.

If the terminal finds a suitable cell, the terminal may transmit second information, and the network device may receive the second information. For example, the terminal may transmit the second information to a first network device to which a first cell belongs. The second information may be forwarded by a third network device and/or a core network device to which a cell that the terminal currently camps on belongs.

If the terminal does not find a suitable cell, the terminal may transmit third information, and the network device may receive the third information. For example, the terminal may transmit the third information to a fourth network device to which a cell around the terminal that supports the first service belongs. The third information may be forwarded by the third network device and/or the core network device to which a cell that the terminal currently camps on belongs.

The second information may be used for indicating that the suitable cell is found by the terminal. The second information may include, for example, one or more of the following information: an identity of the suitable cell, a frequency of the suitable cell, a measurement result of the suitable cell, or indication information of the first service.

The network device may adjust, based on the second information, a threshold for triggering reporting of a measurement report. For example, the second information may include a measurement quantity of a related signal of a suitable cell selected through cell selection after handover failure of the terminal, and the network device may optimize, according to the measurement quantity, the threshold for triggering reporting of the measurement report.

In some embodiments, the network device may determine, based on the second information, an adjustment value X for adjusting the threshold for triggering reporting of the measurement report. For example, the network device may determine, based on the second information, that the adjustment value X is 1 dBm. In a case that the adjustment value X is 4 dBm, if the threshold for triggering reporting of the measurement report before the first handover may be −80 dBm, after MBO is performed, the threshold for triggering reporting of the measurement report may be −76 dBm.

The third information may be used for indicating that the suitable cell is not found by the terminal. The third information may include, for example, one or more of the following information: information for indicating that the suitable cell is not found, indication information of the first service, a measurement result, as detected by the terminal, of a cell that supports the first service; or a setting parameter for cell selection or cell reselection.

The setting parameter for cell selection or cell reselection may be a cell selection parameter or a cell reselection parameter that is set before the first handover. The setting parameter for cell selection or cell reselection may be a parameter related to cell selection or cell reselection. For example, the setting parameter for cell selection or cell reselection may include one or more of the following parameters: an intra-frequency measurement reference signal received power threshold (s-IntraSearchP), an intra-frequency measurement reference signal received quality threshold (s-IntraSearchQ), an inter-frequency/inter-system measurement reference signal received power threshold (s-NonIntraSearchP), an inter-frequency/inter-system measurement reference signal received quality threshold (s-NonIntraSearchQ), a cell minimum receive level (q-RxLevMin), a cell minimum receive level offset (q-RxLevMinOffset), a cell minimum receive level under uplink enhancement (q-RxLevMinSUL), a cell minimum quality level (q-QualMin), or a cell minimum quality level offset (q-QualMinOffset).

A manner in which the terminal acquires the setting parameter for cell selection or cell reselection is not limited in this application. For example, the network device may transmit the setting parameter for cell selection or cell reselection to the terminal. The terminal may acquire the setting parameter for cell selection or cell reselection through one or more of the following messages: dedicated signalling or a cell system broadcast message.

The network device may adjust a cell selection or cell reselection parameter according to the third information. For example, the third information may include a measurement result obtained when the terminal performs cell selection. For example, if the terminal fails to select a suitable target RAT cell after handover failure, the network device may adjust, based on the measurement result obtained when the terminal performs cell selection, a parameter related to an S criterion for cell selection.

In some embodiments, the network device may determine or adjust, based on the third information, an adjustment value corresponding to one or more cell selection or cell reselection parameters. For example, the network device may determine, based on the third information, that an adjustment value Y of a minimum required receive level in a cell is 1 dB; in this case, after MBO, a value of the minimum required receive level in a cell may be increased by 1 dB.

The measurement result, as detected by the terminal, of a cell that supports the first service may include measurement results of one or more cells. Optionally, the measurement result, as detected by the terminal, of a cell that supports the first service may be the highest measurement result, as measured by the terminal, of a neighboring cell. In addition, the fourth network device may be a network device to which the neighboring cell with the highest measurement result belongs. It may be understood that, in a case that the terminal does not find the suitable cell, the terminal transmits the third information to the fourth network device to which a cell with the highest measurement result belongs, so that only the fourth network device adjusts a cell selection criterion, thereby reducing a calculation amount of another network device.

The second information or the third information may be carried in a radio link failure report and/or a logged measurement report. The logged measurement report may be used for recording a measurement result of a cell around the terminal that supports the first service.

Recording with the logged measurement report may be triggered by a first event, where the first event includes a first handover and/or the terminal being out of coverage (out-of-coverage) of a cell that supports the first service. In some embodiments, in a case that the first event includes the terminal being out of coverage of the cell that supports the first service, when the terminal is out of coverage of any neighboring cell that supports the first service, the recording with the logged measurement report may be triggered.

In a case that the first handover fails or radio link failure occurs after the first handover succeeds, the network device may optimize and adjust the first handover according to a cause of first handover failure or a cause of the RLF. The cause of the first handover failure or the cause of the RLF may be obtained from a cause value of RLF or HOF in the radio link failure report. For example, in a case that the first handover failure is caused by failure in contention-based random access and/or failure resulted from that the second cell does not allocate a dedicated random access resource to the terminal, the network device and/or the terminal may, according to the first information, prevent another terminal that has a demand for the first service from being handed over to the second cell.

It may be understood that in a case that the second cell does not allocate a dedicated random access resource to the terminal, or in a case that the first handover fails due to contention-based random access, it is also difficult for another terminal to successfully access the second cell through random access. Therefore, preventing another terminal that has a demand for the first service from being handed over to the second cell may avoid handover failure caused by a similar problem, so that the other terminal may access another cell, thereby improving a handover success rate.

The network device may prevent another terminal that has a demand for the first service from being handed over to the second cell within a period of time. After this period of time expires, the network device may attempt to allow the other terminal that has the demand for the first service to be handed over to the second cell.

The following describes in detail the communication method provided in this application by using three embodiments.

### Embodiment 1

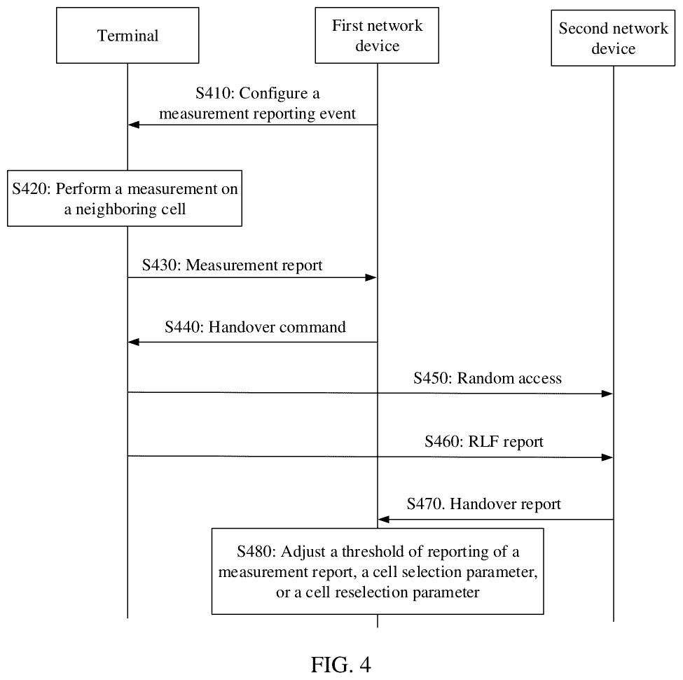

FIG. 4 is a schematic flowchart of a communication method according to Embodiment 1. An example in which a first service is a voice service is used for description in FIG. 4. The method illustrated in FIG. 4 may be performed by a network device and a terminal. The network device may include a first network device to which a first cell belongs, a second network device to which a second cell belongs, and a third network device to which a cell being camped on after a first handover fails or radio link failure occurs belongs. The method illustrated in FIG. 4 may include steps S410 to S480.

Step S410: The network device configures a measurement reporting event for the terminal. For example, the network device may configure a measurement reporting event B1 for the terminal, and the network device configures a measurement reporting event B1 of −80 dBm for the terminal.

Step S420: The terminal performs a measurement on a neighboring cell. The neighboring cell may be an LTE cell that supports a voice service.

Step S430: The terminal transmits a measurement report.

In some embodiments, when finding that there is a neighboring cell meeting a measurement reporting condition, the terminal may transmit the measurement report. For example, a measurement result of the second cell is-79 dBm, which meets the measurement reporting event B1. The terminal may transmit the measurement report to the first cell (namely, a current serving cell).

Step S440: The network device transmits a handover command.

The handover command may be used for implementing a first handover of the terminal from the first cell to the second cell (a target cell). The handover command may be, for example, signalling MobilityFromNRCommand that includes voiceFallbackIndication.

In some embodiments, after receiving a measurement result from the terminal, the first network device to which the first cell belongs may start a handover procedure. After the first network device and a network device for the second cell complete handover preparation work, the first network device may transmit the handover command to the terminal.

Step S450: The terminal performs random access to the second cell.

In some cases, a problem may occur in a random access procedure performed by the terminal. For example, the terminal fails to receive Msg2 transmitted by the network device. A problem of random access will cause failure of a first handover.

In some cases, the terminal completes the random access to the second cell successfully, but RLF occurs in the second cell shortly thereafter.

Step S460: The terminal transmits a radio link failure report.

The radio link failure report may include first information.

In some embodiments, after re-accessing the network, the terminal may forward, through a currently camped-on cell, the radio link failure report to the second cell which was to be handed over to.

The network device may determine, based on the first information in the radio link failure report, that MRO needs to be performed on the first handover. For example, based on the first information, the network device may determine, according to timeConnFailure being less than a specific threshold or according to a problem encountered in the random access procedure, that MRO needs to be performed on the first handover.

Step S470: The second network device transmits a handover report. The handover report may be transmitted to a network device in which the first cell is located.

Step S480: The first network device adjusts one or more of a threshold for triggering reporting of a measurement report, a cell selection parameter, or a cell reselection parameter.

For example, according to the handover report, the first cell may adjust a threshold for triggering a measurement reporting event B1 (for example, increase the threshold to −72 dBm).

Optionally, an adjustment amount may be determined by referring to a cell signal measurement result that is transmitted by the terminal when the terminal subsequently finds a suitable E-UTRA cell.

### Embodiment 2

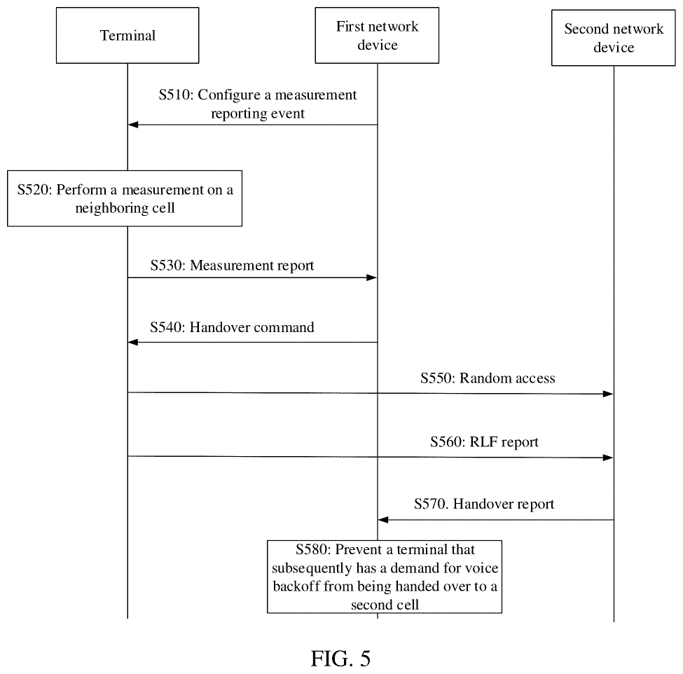

FIG. 5 is a schematic flowchart of a communication method according to Embodiment 2. An example in which a first service is a voice service is used for description in FIG. 5. The method illustrated in FIG. 5 may be performed by a network device and a terminal. The network device may include a first network device to which a first cell belongs, a second network device to which a second cell belongs, and a third network device to which a cell being camped on after a first handover fails or radio link failure occurs belongs. The method illustrated in FIG. 5 may include steps S510 to S580.

Step S510: The network device configures a measurement reporting event for the terminal. For example, the network device may configure a measurement reporting event B1 for the terminal, and the network device configures a measurement reporting event B1 of −80 dBm for the terminal.

Step S520: The terminal performs a measurement on a neighboring cell. The neighboring cell may be an LTE cell that supports a voice service.

Step S530: The terminal transmits a measurement report.

In some embodiments, when finding that there is a neighboring cell meeting a measurement reporting condition, the terminal may transmit the measurement report. For example, a measurement result of the second cell is −79 dBm, which meets the measurement reporting event B1. The terminal may transmit the measurement report to the first cell (namely, a current serving cell).

Step S540: The network device transmits a handover command.

The handover command may be used for implementing a first handover of the terminal from the first cell to the second cell (namely, a target cell). The handover command may be, for example, signalling MobilityFromNRCommand that includes voiceFallbackIndication.

In some embodiments, after receiving a measurement result from the terminal, the first network device to which the current serving cell belongs may start a procedure of the first handover. After the first network device and a network device for the second cell complete handover preparation work, the first network device may transmit the handover command to the terminal.

Step S550: The terminal performs random access to the second cell, to implement the first handover.

In some cases, the terminal may encounter a problem in a process of performing random access to the second cell, thus failing to complete the first handover. For example, failure always occurs in a process of contention-based random access performed by the terminal, or the second cell does not allocate a dedicated random access resource to the terminal.

Step S560: The terminal transmits a radio link failure report.

The radio link failure report may include first information.

In some embodiments, after re-accessing the network, the terminal may forward, through a currently camped-on cell, the radio link failure report to the second cell which was to be handed over to.

The network device may determine, based on the first information in the radio link failure report, that the terminal encounters a problem of random access.

Step S570: The second network device transmits a handover report. The handover report may be transmitted to a network device in which the first cell is located.

Step S580: The first network device may prevent a terminal that subsequently has a voice backoff requirement from being handed over to the second cell.

### Embodiment 3

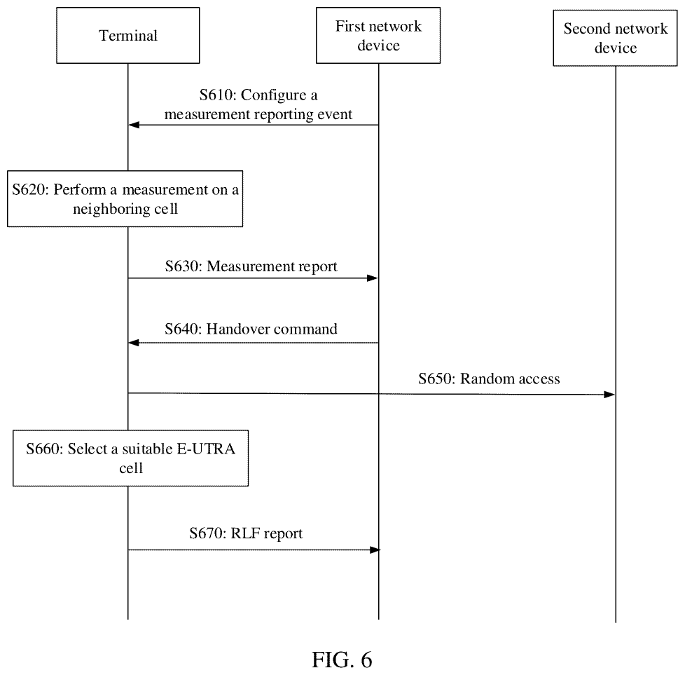

FIG. 6 is a schematic flowchart of a communication method according to Embodiment 3. An example in which a first service is a voice service is used for description in FIG. 6. The method illustrated in FIG. 6 may be performed by a network device and a terminal. The network device may include a first network device to which a first cell belongs, a second network device to which a second cell belongs, a third network device to which a cell being camped on after a first handover fails or radio link failure occurs belongs, and a fourth network device to which an E-UTRAN cell measured by the terminal belongs. The method illustrated in FIG. 6 may include steps S610 to S670.

Step S610: The network device configures a measurement reporting event for the terminal. For example, the network device may configure a measurement reporting event B1 for the terminal, and the network device configures a measurement reporting event B1 of −80 dBm for the terminal.

Step S620: The terminal performs a measurement on a neighboring cell. The neighboring cell may be an LTE cell that supports a voice service.

Step S630: The terminal transmits a measurement report.

In some embodiments, when finding that there is a neighboring cell meeting a measurement reporting condition, the terminal may transmit the measurement report. For example, a measurement result of the second cell is-79 dBm, which meets the measurement reporting event B1. The terminal may transmit the measurement report to the first cell (namely, a current serving cell).

Step S640: The network device transmits a handover command.

The handover command may be used for implementing a first handover of the terminal from the first cell to the second cell (namely, a target cell). The handover command may be, for example, signalling MobilityFromNRCommand that includes voiceFallbackIndication.

In some embodiments, after receiving a measurement result from the terminal, the first network device to which the current serving cell belongs may start a procedure of the first handover. After the first network device and a network device for the second cell complete handover preparation work, the first network device may transmit the handover command to the terminal.

Step S650: The terminal performs random access to the second cell, to implement the first handover.

In some cases, the terminal may encounter a problem in a process of performing random access to the second cell, thus failing to complete the first handover. For example, failure always occurs in a process of contention-based random access performed by the terminal; or the second cell does not allocate a dedicated random access resource to the terminal; or the terminal fails to receive Msg2 transmitted by the network device.

In some cases, the terminal completes the random access to the second cell successfully, but RLF occurs in the second cell shortly thereafter.

Step S660: In a case that the first handover fails, or RLF occurs after the first handover succeeds, the terminal may select a suitable E-UTRA cell. The terminal may determine the suitable E-UTRAN cell based on a cell selection parameter or a cell reselection parameter.

Step S670: The terminal transmits a radio link failure report.

The radio link failure report may include first information.

If the terminal does not find a suitable E-UTRA cell, the terminal may transmit third information to the network device. The third information may include one or more of the following information: information for indicating that the suitable E-UTRA cell is not found, a measurement result of a measured E-UTRA cell, or an ID of a corresponding E-UTRA cell.

The third information may be recorded in a radio link failure report or other signalling (such as a logged measurement report).

The third information may be transmitted to a cell that is successfully reestablished. The cell that is successfully reestablished may be, for example, the first cell.

The network device in which the first cell is located may transmit (may be forwarded by using a core network) the third information (for example, including the highest measurement result of an E-UTRA cell as measured by the terminal, and information for indicating that a suitable E-UTRA cell is not found) and the first information to a fourth network device in which the E-UTRA cell corresponding to the highest measurement result is located. The fourth network device may adjust, based on the third information, a parameter corresponding to a cell selection criterion and/or a cell reselection criterion for determining whether a cell is suitable for the terminal to be camped on.

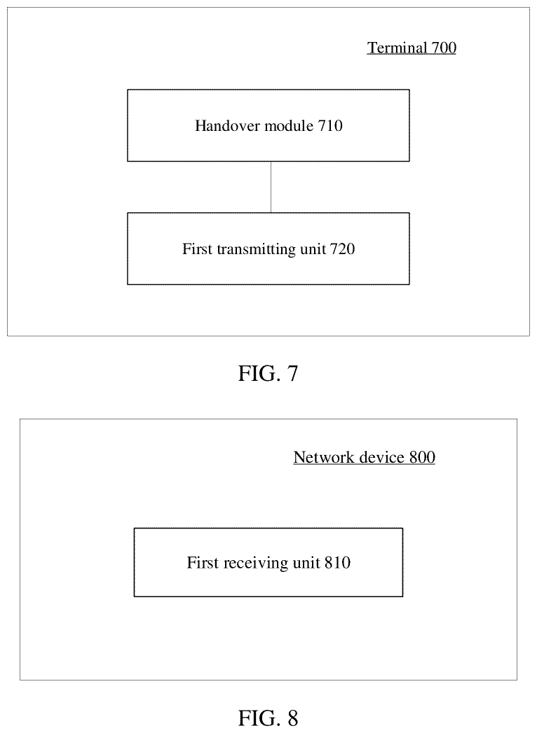

The method embodiments of this application are described in detail above with reference to FIG. 1 to FIG. 6. Apparatus embodiments of this application are described in detail below with reference to FIG. 7 to FIG. 9. It should be understood that the description of the method embodiments corresponds to the description of the apparatus embodiments mutually, and therefore, for parts that are not described in detail, reference may be made to the foregoing method embodiments.

FIG. 7 is a schematic structural diagram of a terminal 700 according to an embodiment of this application. The terminal shown in FIG. 7 may include a handover unit 710 and a first transmitting unit 720.

The handover unit 710 is configured to perform a first handover from a first cell to a second cell for enabling the terminal to perform a first service, where the first cell does not support the first service, and the second cell supports the first service.

The first transmitting unit 720 is configured to: in a case that the first handover fails, or radio link failure occurs after the first handover succeeds, transmit first information, where the first information is used for improving mobility robust optimization MRO.

Optionally, the terminal 700 may further include: a selection unit, configured to: in a case that the first handover fails, or radio link failure occurs after the first handover succeeds, perform cell selection to search for a suitable cell, where the suitable cell supports the first service; a second transmitting unit, configured to: in a case that the terminal finds the suitable cell, transmit second information, where the second information is used for indicating that the suitable cell is found by the terminal; and a third transmitting unit, configured to: in a case that the terminal does not find the suitable cell, transmit third information, where the third information is used for indicating that the suitable cell is not found by the terminal.

Optionally, the second information is used for adjusting a threshold for triggering reporting of a measurement report, and the third information is used for adjusting one or more of following parameters: the threshold for triggering reporting of the measurement report, a cell selection parameter, or a cell reselection parameter.

Optionally, the second information includes one or more of the following information: an identity of the suitable cell; a frequency of the suitable cell; a measurement result of the suitable cell; or indication information of the first service.

Optionally, the third information includes one or more of the following information: information for indicating that the suitable cell is not found, indication information of the first service, a measurement result of a cell that supports the first service; or a setting parameter for cell selection or cell reselection.

Optionally, the setting parameter for cell selection or cell reselection includes one or more of the following parameters: an intra-frequency measurement reference signal received power threshold, an intra-frequency measurement reference signal received quality threshold, an inter-frequency/inter-system measurement reference signal received power threshold, an inter-frequency/inter-system measurement reference signal received quality threshold, a cell minimum receive level, a cell minimum receive level offset, a cell minimum receive level under uplink enhancement, a cell minimum quality level, or a cell minimum quality level offset.

Optionally, the terminal acquires the setting parameter for cell selection or cell reselection through one or more of the following messages: dedicated signalling or a cell system broadcast message.

Optionally, the second information or the third information is carried in one or more of the following messages: a radio link failure report; or a logged measurement report.

Optionally, the logged measurement report is used for recording a measurement result of a cell around the terminal that supports the first service.

Optionally, recording with the logged measurement report is triggered by a first event, and the first event includes the first handover and/or the terminal being out of coverage of the second cell.

Optionally, the cell that supports the first service is an E-UTRA cell.

Optionally, in a case that failure of the first handover is caused by failure in contention-based random access and/or failure resulted from that the second cell does not allocate a dedicated random access resource to the terminal, the first information is further used by a network device to prevent another terminal that has a demand for the first service from being handed over to the second cell.

Optionally, the first information is carried in a radio link failure report.

Optionally, the first service is a voice service, and the first handover is an inter-system handover for voice fallback.

FIG. 8 is a schematic structural diagram of a network device 800 according to an embodiment of this application. The network device 800 may include a first receiving unit 810.

The first receiving unit 810 is configured to: in a case that a first handover fails, or radio link failure occurs after the first handover succeeds, receive first information, where the first information is used for improving mobility robust optimization MRO. The first handover is a handover of a terminal from a first cell to a second cell for enabling the terminal to perform a first service, where the first cell does not support the first service, and the second cell supports the first service.

Optionally, the network device 800 may further include: a second receiving unit, configured to: in the case that the first handover fails, or radio link failure occurs after the first handover succeeds, if the terminal finds a suitable cell that supports the first service, receive second information, where the second information is used for indicating that the suitable cell is found by the terminal; and a third receiving unit, configured to: in the case that the first handover fails, or radio link failure occurs after the first handover succeeds, if the terminal does not find the suitable cell, receive third information, where the third information is used for indicating that the suitable cell is not found by the terminal.

Optionally, the second information is used for adjusting a threshold for triggering reporting of a measurement report. The third information is used for adjusting one or more of following parameters: the threshold for triggering reporting of the measurement report, a cell selection parameter, or a cell reselection parameter.

Optionally, the second information includes one or more of the following information: an identity of the suitable cell; a frequency of the suitable cell; a measurement result of the suitable cell; or indication information of the first service.

Optionally, the third information includes one or more of the following information: information for indicating that the suitable cell is not found, indication information of the first service, a measurement result, as detected by the terminal, of a cell that supports the first service; or a setting parameter for cell selection or cell reselection.

Optionally, the setting parameter for cell selection or cell reselection includes one or more of the following parameters: an intra-frequency measurement reference signal received power threshold, an intra-frequency measurement reference signal received quality threshold, an inter-frequency/inter-system measurement reference signal received power threshold, an inter-frequency/inter-system measurement reference signal received quality threshold, a cell minimum receive level, a cell minimum receive level offset, a cell minimum receive level under uplink enhancement, a cell minimum quality level, or a cell minimum quality level offset.

Optionally, the terminal acquires the setting parameter for cell selection or cell reselection through one or more of the following messages: dedicated signalling or a cell system broadcast message.

Optionally, the second information or the third information is carried in one or more of the following messages: a radio link failure report; or a logged measurement report.

Optionally, the logged measurement report is used for recording a measurement result of a cell around the terminal that supports the first service.

Optionally, recording with the logged measurement report is triggered by a first event, and the first event includes the first handover and/or the terminal being out of coverage of the second cell.

Optionally, the cell that supports the first service is an E-UTRA cell.

Optionally, in a case that failure of the first handover is caused by failure in contention-based random access and/or failure resulted from that the second cell does not allocate a dedicated random access resource to the terminal, the first information is further used by the network device to prevent another terminal that has a demand for the first service from being handed over to the second cell.

Optionally, the first information is carried in a radio link failure report.

Optionally, the first service is a voice service, and the first handover is an inter-system handover for voice fallback.

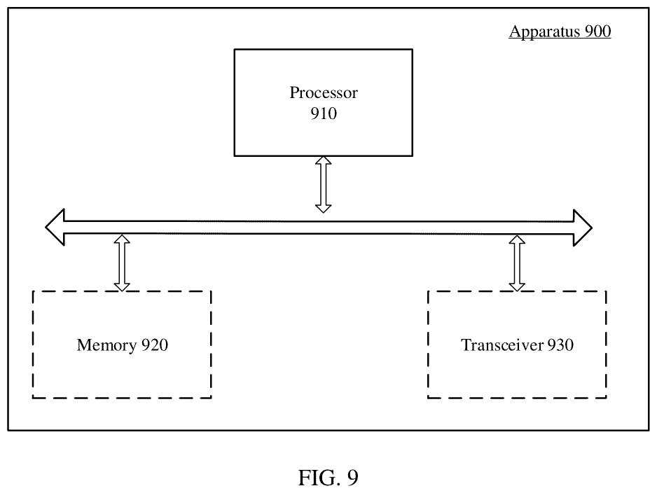

FIG. 9 is a schematic diagram of a structure of a communications apparatus 900 according to an embodiment of this application. Dashed lines in FIG. 9 indicate that the unit or module is optional. The apparatus 900 may be configured to implement the methods described in the foregoing method embodiments. The apparatus 900 may be a chip, a terminal device, or a network device.

The apparatus 900 may include one or more processors 910. The processor 910 may allow the apparatus 900 to implement a method described in the foregoing method embodiments. The processor 910 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field-programmable gate array (FPGA) or another programmable logic device, a discrete gate or transistor logic device, a discrete hardware component, or the like. The general-purpose processor may be a microprocessor, or the processor may be any conventional processor or the like.

The apparatus 900 may further include one or more memories 920. The memory 920 stores a program. The program may be executed by the processor 910, to cause the processor 910 to perform a method described in the foregoing method embodiments. The memory 920 may be separate from the processor 910 or may be integrated into the processor 910.

The apparatus 900 may further include a transceiver 930. The processor 910 may communicate with another device or chip via the transceiver 930. For example, the processor 910 may send data to and receive data from another device or chip via the transceiver 930.

An embodiment of this application further provides a computer-readable storage medium for storing a program. The computer-readable storage medium may be applied to a terminal or a network device provided in embodiments of this application, and the program causes a computer to execute the methods performed by the terminal or the network device in various embodiments of this application.

An embodiment of this application further provides a computer program product. The computer program product includes a program. The computer program product may be applied in a terminal or a network device provided in embodiments of this application, and the program causes a computer to execute the methods performed by the terminal or the network device in various embodiments of this application.

An embodiment of this application further provides a computer program. The computer program may be applied in a terminal or a network device provided in embodiments of this application, and the computer program causes a computer to execute the methods performed by the terminal or the network device in various embodiments of this application.

It should be understood that the terms “system” and “network” in this application may be used interchangeably. In addition, the terms used in this application are only used to illustrate specific embodiments of this application, but are not intended to limit this application. The terms “first”, “second”, “third”, “fourth”, and the like in the specification, claims, and drawings of this application are used for distinguishing different objects from each other, rather than defining a specific order. In addition, the terms “include” and “have” and any variations thereof are intended to cover a non-exclusive inclusion.

In embodiments of this application, the “indication” mentioned may be a direct indication or an indirect indication, or indicate an association. For example, A indicates B, which may mean that A directly indicates B, for example, B may be obtained by means of A; or may mean that A indirectly indicates B, for example, A indicates C, and B may be obtained by means of C; or may mean that there is an association relationship between A and B.

In embodiments of this application, “B corresponding to A” means that B is associated with A, and B may be determined based on A. However, it should be further understood that determining B based on A does not mean determining B based on only A, but instead B may be determined based on A and/or other information.

In embodiments of this application, the term “corresponding to” may mean that there is a direct or indirect correspondence between two elements, or that there is an association relationship between two elements, or that there is a relationship of “indicating” and “being indicated”, “configuring” and “being configured”, or the like.

In embodiments of this application, the terms “being predefined” or “being pre-configured” may be implemented in a manner in which corresponding code, a table, or other related information used for indication is pre-stored in a device (for example, including the terminal device and the network device), and a specific implementation thereof is not limited in this application. For example, the term “being pre-defined” may refer to being as defined in a protocol.

In embodiments of this application, the “protocol” may indicate a standard protocol in the communication field, which may include, for example, an LTE protocol, an NR protocol, and a related protocol applied to a future communications system. This is not limited in this application.

In embodiments of this application, the term “and/or” is merely an association relationship that describes associated objects, and represents that there may be three relationships. For example, A and/or B may represent three cases: only A exists, both A and B exist, and only B exists. In addition, the character “/” herein generally indicates an “or” relationship between the associated objects.

In embodiments of this application, sequence numbers of the foregoing processes do not mean execution sequences. The execution sequences of the processes should be determined according to functions and internal logic of the processes, and should not be construed as any limitation on the implementation processes of embodiments of this application.

In several embodiments provided in this application, it should be understood that, the disclosed system, apparatus, and method may be implemented in other manners. For example, the above described apparatus embodiments are merely illustrative. For example, the division of a unit as described is merely logical function division and there may be other division in actual implementation. For example, a plurality of units or components may be combined or integrated into another system, or some features may be ignored or not executed. In addition, the displayed or discussed mutual couplings or direct couplings or communication connections may be implemented by using some interfaces. The indirect couplings or communication connections between apparatuses or units may be implemented in electrical, mechanical, or other forms.

The units illustrated as separate components may be or may not be physically separated, and the components displayed as units may be or may not be physical units, that is, may be located in one place or distributed on a plurality of network units. Some or all of the units may be selected according to actual needs to achieve the objective of the solutions of the embodiments.

In addition, function units in embodiments of this application may be integrated into one processing unit, or each of the units may exist alone physically, or two or more units may be integrated into one unit.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (DSL)) manner or a wireless (such as infrared, radio, and microwave) manner. The computer-readable storage medium may be any available medium readable by the computer, or a data storage device, such as a server or a data center integrated with one or more available media. The available medium may be a magnetic medium (for example, a floppy disk, a hard disk, or a magnetic tape), an optical medium (for example, a digital video disc (DVD)), a semiconductor medium (for example, a solid-state drive (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

1. A terminal, comprising a memory and a processor, wherein the memory is configured to store a program, and the processor is configured to invoke the program in the memory to cause the terminal to perform:
performing a first handover from a first cell to a second cell for enabling the terminal to perform a first service, wherein the first cell does not support a first service, and the second cell supports the first service; and
in a case that the first handover fails, or radio link failure occurs after the first handover succeeds, transmitting first information, wherein the first information is used for optimizing mobility network parameter setting and/or performing mobility robust optimization.

2. The terminal according to claim 1, wherein the processor is further configured to invoke the program in the memory to cause the terminal to perform:
in the case that the first handover fails, or the radio link failure occurs after the first handover succeeds, performing cell selection or cell reselection to search for a suitable cell that supports the first service; and
in a case that the terminal finds the suitable cell, transmitting second information, wherein the second information is used for indicating that the suitable cell is found by the terminal;
in a case that the terminal does not find the suitable cell, transmitting third information, wherein the third information is used for indicating that the suitable cell is not found by the terminal.

3. The terminal according to claim 2, wherein
the second information is used for adjusting a threshold for triggering reporting of a measurement report; and
the third information is used for adjusting one or more of following parameters: the threshold for triggering reporting of the measurement report, a cell selection parameter, or a cell reselection parameter.

4. The terminal according to claim 2, wherein the second information comprises one or more of following information:
an identity of the suitable cell;
a frequency of the suitable cell;
a measurement result of the suitable cell; or
indication information of the first service.

5. The terminal according to claim 2, wherein the third information comprises one or more of following information:
information for indicating that the suitable cell is not found;
indication information of the first service;
a measurement result of the cell that supports the first service; or
a setting parameter for cell selection or cell reselection.

6. The terminal according to claim 5, wherein the setting parameter for cell selection or cell reselection comprises one or more of following parameters:
an intra-frequency measurement reference signal received power threshold, an intra-frequency measurement reference signal received quality threshold, an inter-frequency/inter-system measurement reference signal received power threshold, an inter-frequency/inter-system measurement reference signal received quality threshold, a cell minimum receive level, a cell minimum receive level offset, a cell minimum receive level under uplink enhancement, a cell minimum quality level, or a cell minimum quality level offset.

7. The terminal according to claim 5, wherein the terminal obtains the setting parameter for cell selection or cell reselection by using one or more of following messages:
dedicated signalling; or
a cell system broadcast message.

8. The terminal according to claim 2, wherein the second information or the third information is carried in one or more of following messages:
a radio link failure report; or
a logged measurement report.

9. The terminal according to claim 8, wherein the logged measurement report is used for recording a measurement result of a cell around the terminal that supports the first service.

10. The terminal according to claim 9, wherein recording with the logged measurement report is triggered by a first event, and the first event comprises the first handover and/or the terminal being out of coverage of a cell that supports the first service.

11. The terminal according to claim 5, wherein the cell that supports the first service is an evolved universal terrestrial radio access (E-UTRA) cell.

12. The terminal according to claim 1, wherein in a case that failure of the first handover is caused by failure in contention-based random access and/or failure resulted from that the second cell does not allocate a dedicated random access resource to the terminal, the first information is further used for preventing another terminal that has a demand for the first service from being handed over to the second cell.

13. The terminal according to claim 1, wherein the first information is carried in a radio link failure report.

14. The terminal according to claim 1, wherein the first service is a voice service, and the first handover is an inter-system handover for voice fallback.

15. A network device, comprising a memory and a processor, wherein the memory is configured to store a program, and the processor is configured to invoke the program in the memory to cause the network device to perform:
in a case that a first handover fails, or radio link failure occurs after the first handover succeeds, receiving first information, wherein the first information is used for optimizing mobility network parameter setting and/or performing mobility robust optimization,
wherein the first handover is a handover of a terminal from a first cell to a second cell for enabling the terminal to perform a first service, the first cell does not support the first service, and the second cell supports the first service.

16. The network device according to claim 15, wherein the first information is carried in a radio link failure report.

17. The network device according to claim 15, wherein the first service is a voice service, and the first handover is an inter-system handover for voice fallback.

18. A communication method, wherein the method comprises:
performing, by a terminal, a first handover from a first cell to a second cell for enabling the terminal to perform a first service, wherein the first cell does not support a first service, and the second cell supports the first service; and
in a case that the first handover fails, or radio link failure occurs after the first handover succeeds, transmitting, by the terminal, first information, wherein the first information is used for optimizing mobility network parameter setting and/or performing mobility robust optimization.

19. The method according to claim 18, wherein the first information is carried in a radio link failure report.

20. The method according to claim 18, wherein the first service is a voice service, and the first handover is an inter-system handover for voice fallback.
